(19) United States
(12) Patent Application Publication
(10) Pub. No.: US 2010/0212355 A1
(43) Pub. Date: Aug. 26, 2010

(54) BROKEN HEART NECKLACE-URN

(76) Inventor: Antoine Elhaj, Sandusky, OH (US)

Correspondence Address: RONALD J. KOCH, 698 MORRISON RD., SUITE B, COLUMBUS, OH, 43213, US

(21) Appl. No.: 12/497,395

(22) Filed: Jul. 2, 2009

Related U.S. Application Data
(63) Continuation-in-part of application No. 12/492,949, filed on Jun. 26, 2009.
Application No. 12/492,949 is a continuation-in-part of application No. 12/468,861, filed on May 19, 2009.
Application No. 12/468,861 is a continuation-in-part of application No. 12/430,882, filed on Apr. 27, 2009.
Application No. 12/430,882 is a continuation-in-part of application No. 12/390,400, filed on Feb. 20, 2009.

(51) Int. Cl. A44C 25/00; A44C 13/00; A61G 17/08

(52) U.S. Cl. 63/1.14; 63/1.16; 27/1

(57) ABSTRACT

A complementary pair of broken heart shaped urn pendants, each having an access port, magnet, jagged inner surface, curved outer surface, clasp, front vertical wall, and rear vertical wall, and means for removably securing the pair together.

### CROSS REFERENCE TO RELATED APPLICATIONS

application Ser. No. 12/492,949, filed Jun. 26, 2009; Ser. No. 12/468,861, filed May 19, 2009; Ser. No. 12/390,400, filed Feb. 20, 2009; Ser. No. 12/430,882, filed Apr. 27, 2009.

### CLAIM OF PRIORITY BASED ON COPENDING APPLICATION

claims benefit of utility application Ser. Nos. 12/492,949, 12/468,861, 12/390,400 & 12/430,882

The present application is a continuation in part of co-pending patent application Nos:

Ser. No. 12/492,949, of Antoine Elhaj, filed Jun. 26, 2009, entitled “Coffin Carriage Assembly”;

Ser. No. 12/468,861 of Antoine Elhaj, filed May 19, 2009, entitled “Broken Heart Shaped Vault”;

Ser. No. 12/430,882 of Antoine Elhaj, filed Apr. 27, 2009, entitled “Broken Heart Shaped Coffin”;

and Ser. No. 12/390,400 of Antoine Elhaj, filed Feb. 20, 2009, entitled “Broken Heart Shaped Coffin” and based on which priority is herewith claimed under 35 U.S.C. 120 and the disclosures of which are incorporated herein by reference in their entirety as if fully rewritten herein.

### FEDERALLY SPONSORED RESEARCH

Not Applicable

### SEQUENCE LISTING, TABLE, OR COMPUTER PROGRAM COMPACT DISK APPENDIX

Not Applicable

### BACKGROUND AND SUMMARY

The present invention relates generally to urns and specifically to pendants and keys adapted to be urns. A broken heart shaped urn pendant can be worn alone as a necklace or in combination with a second broken heart shaped urn pendant (that is a mirror image of the first pendant) to form a unitary heart. Thus, the ashes of one or two persons or pets can be worn as jewelry. Additionally, a key is provided that has an inner portion adapted for use as an urn.

### BRIEF DESCRIPTION OF THE DRAWINGS

FIG. 1 depicts a perspective view of one embodiment of the key-urn of the present invention

FIG. 2 depicts a front view of one embodiment of the key-urn of the present invention

FIG. 3 depicts a front view of one embodiment of the key-urn of the present invention

FIG. 4 depicts a side view of one embodiment of the key-urn of the present invention

FIG. 5 depicts a front view of one embodiment of the pendant-urn of the present invention

FIG. 6 depicts a perspective view of one embodiment of the pendant-urn of the present invention

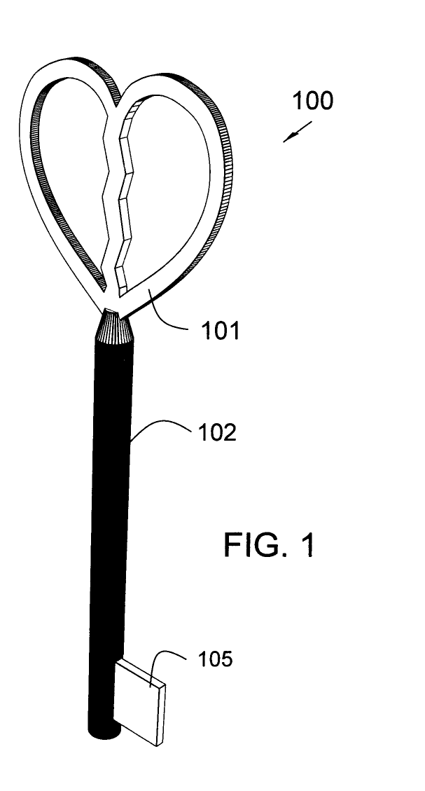

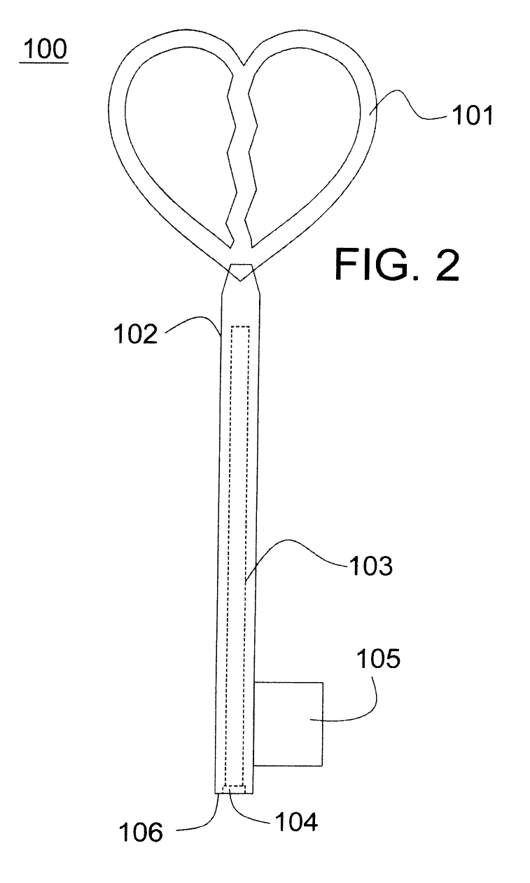

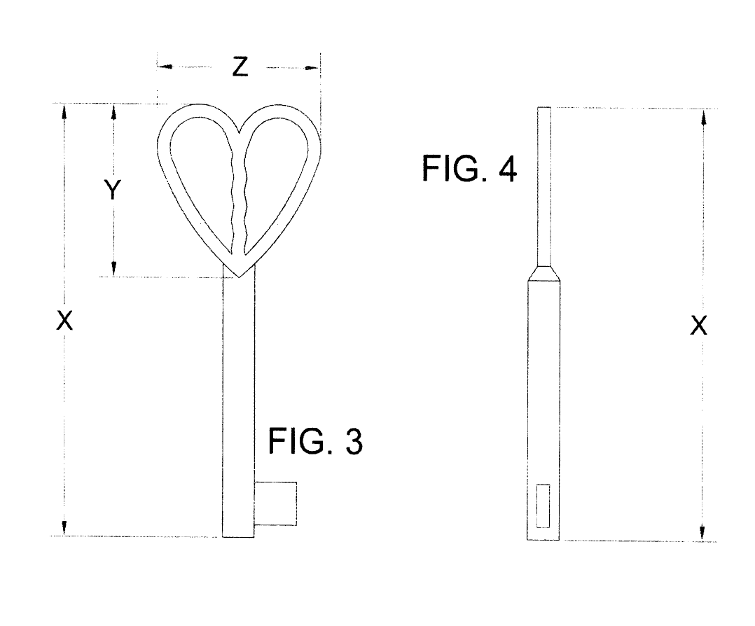

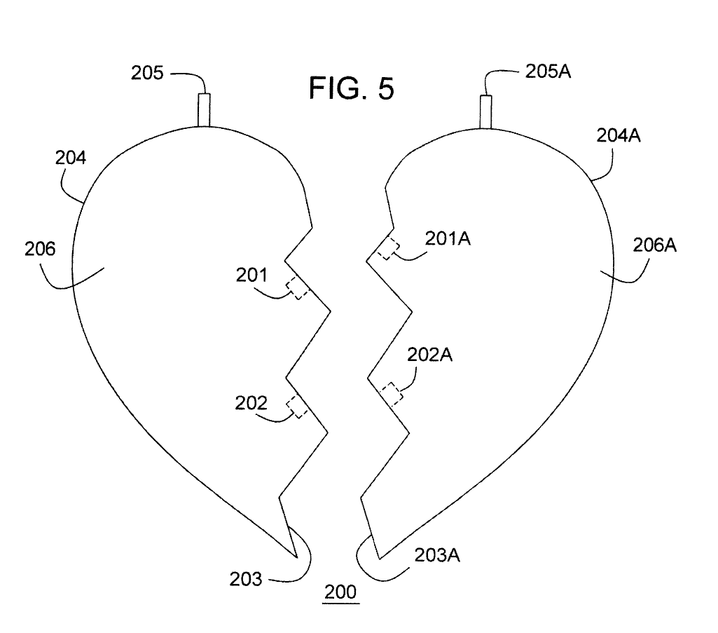

### REFERENCE NUMERALS IN DRAWINGS

The table below lists the reference numerals employed in the figures, and identifies the element designated by each numeral.
100 key 100
101 key handle 101
102 key shaft 102
103 shaft inner chamber 103 of key
104 chamber cap 104 of key shaft
105 lock engagement means 105 of key shaft
106 key bottom 106
200 broken heart shaped urn pendant 200
201 access port 201 of broken heart shaped urn
202 magnet 202 of broken heart shaped urn
203 jagged inner surface 203 of broken heart shaped urn
204 curved outer surface 204 of broken heart shaped urn
205 clasp 205 of broken heart shaped urn
206 front vertical wall 206 of broken heart shaped urn
207 rear vertical wall 207 of broken heart shaped urn
200A complementary broken heart shaped urn pendant 200A
201A access port 201A of complementary broken heart shaped urn
202A magnet 202A of complementary broken heart shaped urn
203A jagged inner surface 203A of complementary broken heart shaped urn
204A curved outer surface 204A of complementary broken heart shaped urn
205A clasp 205A of complementary broken heart shaped urn
206A front vertical wall 206A of broken heart shaped urn
207A rear vertical wall 207A of broken heart shaped urn

### DETAILED DESCRIPTION

A broken heart shaped urn pendant 200 comprises, access port 201, magnet 202, jagged inner surface 203, curved outer surface 204, clasp 205, front vertical wall 206, and rear vertical wall 207.

Curved outer surface 204 forms essentially a half-heart shape; jagged inner surface 203 forms essentially the broken shape; and front and rear vertical walls 206, 207 complete the vessel.

Access port 201 has a removable cap (not shown) for sealing the vessel. It is preferably upwardly oriented so as not to spill the ashes when the cap is removed when the urn is upright. Ashes can be placed inside of the urn via the access port for storage and remembrance.

In one embodiment, access port 201 and removable cap are recessed in the jagged inner surface so as not to protrude outwardly.

In one embodiment, a second, complementary broken heart shaped urn pendant 200A, is provided to be conjoined to a first pendant 200 to form a heart shape, and has access port 201A, magnet 202A, jagged inner surface 203A, curved outer surface 204A, clasp 205A, front vertical wall 206A, and rear vertical wall 207A.

The arrangement of curved outer surface 204A, jagged inner surface 203A, front and rear vertical walls 206A, 207A, and access port 201A (with removable cap) is analogous to (except being a mirror image of) curved outer surface 204, jagged inner surface 203, front and rear vertical walls 206, 207, and access port 201.

In one embodiment, means for removably connecting the complementary pendants to each other comprises, complementary magnets 202, 202A each placed in a recess (i.e. flush mounted) on the jagged inner surface 203, 203A of each urn in a cooperating arrangement. The magnets are chosen with appropriate pole alignment so they are not repelled from each other.

In one embodiment, means for removably connecting the complementary pendants to each other comprises, a magnet 202 placed in a recess on the jagged inner surface 203 of one of the urns, the other urn having a coinciding ferrous portion (taking the place of magnet 202A) on jagged inner surface 203A. Thus, the complementary urns as described can be worn either separately or conjoined to form a heart shape.

Access port 201, 201A (each with removable cap) are preferably recessed in the jagged inner surface of each urn so as not to protrude from the surface. Though not essential, this arrangement is advantageous in that the access ports are not visible when the urns are worn in a complementary fashion.

A broken heart shaped urn key comprises key 100, key handle 101, key shaft 102, shaft inner chamber 103, chamber cap 104, lock engagement means 105, and key bottom 106.

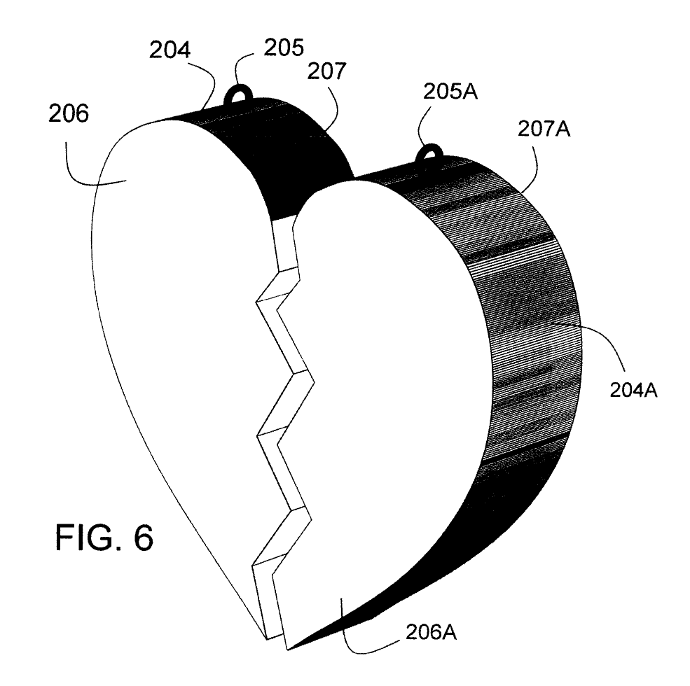

Handle portion 101 is shaped like a complementary broken heart pair in the frontal view; tubular shaft 102 is connected at an upper portion to handle 101; lock engagement means (a.k.a. tooth, etc.) 105 is disposed approximate a bottom portion 106 of shaft 102 which has an opening in the bottom thereof and forms an inner chamber 103 within the shaft; and removable cap (e.g. a threaded screw) 104 is used for sealing the opening; Thus, the inner chamber can be filled with ashes and sealed with the removable cap. In one embodiment (FIGS. 6 & 7), the key has dimensions of X=2.5 inches, Y=1 inch, and Z=0.97 inches.

What is claimed is:

1. A broken heart shaped urn pendant comprising:
a curved outer surface;
a jagged inner surface;
front and rear vertical walls;
and an access port having a removable cap;
whereby ashes can be placed inside of the urn via the access port.

2. The broken heart shaped urn pendant of claim 1 further comprising:
the access port and removable cap being recessed in the jagged inner surface.

3. Complementary broken heart shaped urn pendants comprising:
first and second broken heart shaped urn pendants, each having,
a curved outer surface,
a jagged inner surface,
front and rear vertical walls,
and an access port having a removable cap;
and means for removably connecting the complementary pendants to each other;
whereby the complementary urns can be worn either separately or conjoined to form a heart shape.

4. The complementary broken heart shaped urn pendants of claim 3 wherein
the access port and removable cap being recessed in the jagged inner surface of each urn.

5. The complementary broken heart shaped urn pendants of claim 3 wherein the means for removably connecting the complementary pendants to each other comprises:
complementary magnets placed in a recess on the jagged inner surface of each urn in a cooperating arrangement.

6. The complementary broken heart shaped urn pendants of claim 3 wherein the means for removably connecting the complementary pendants to each other comprises:
a magnet placed in a recess on the jagged inner surface of one of the urns, the other urn having a coinciding ferrous portion on the jagged inner surface thereof.

7. A broken heart shaped urn key comprising:
a handle portion shaped like a complementary broken heart pair in the frontal view;
a tubular shaft connected at an upper portion to the handle;
lock engagement means disposed approximate a bottom portion of the shaft;
the shaft having an opening in the bottom thereof and forming an inner chamber within the shaft;
and a removable cap for sealing the opening;
whereby the inner chamber can be filled with ashes and sealed with the removable cap.

8. The broken heart shaped urn key of claim 7 further comprising:
the removable cap is a threaded cap that is removably connectable to a threaded opening in the bottom of the shaft.
